(19) United States
(12) Patent Application Publication
(10) Pub. No.: US 2025/0384175 A1
(43) Pub. Date: Dec. 18, 2025

(54) METHOD AND SYSTEM FOR SETTING HEALTH MONITORING WARNING THRESHOLDS OF LONG-SPAN ARCH BRIDGES BASED ON RELIABILITY CRITERIA

(71) Applicant: Chongqing Jiaotong University, Chongqing (CN)

(72) Inventors: Jingzhou XIN, Chongqing (CN); Qizhi TANG, Chongqing (CN); Jianting ZHOU, Chongqing (CN); Hong ZHANG, Chongqing (CN); Yan JIANG, Chongqing (CN); Bo WU, Chongqing (CN); Fengbo WU, Chongqing (CN); Kang WANG, Chongqing (CN); Helu YU, Chongqing (CN)

(73) Assignee: Chongqing Jiaotong University, Chongqing (CN)

(21) Appl. No.: 19/237,084

(22) Filed: Jun. 13, 2025

(30) Foreign Application Priority Data
Jun. 18, 2024 (CN) 202410796540.9

(51) Int. Cl. G06F 30/13

(52) U.S. Cl. CPC G06F 30/13

(57) ABSTRACT

A method and a system for setting health monitoring warning thresholds of long-span arch bridges based on reliability criteria are provided. The method includes establishing a performance function based on structural ultimate responses and warning thresholds of the long-span arch bridge; determining target reliability indices, setting initial values of random variables and warning thresholds, and defining convergence tolerance errors; calculating gradient values of the performance function, computing scaling factors based on the gradient values, obtaining failure points of the performance function through the scaling factors combined with a conjugate search strategy, and updating warning thresholds at the failure points; iterating until errors become less than or equal to the convergence tolerance errors to establish reliability criteria for warning threshold configuration; and deriving warning thresholds corresponding to target reliability indices according to the reliability criteria.

### CROSS-REFERENCE TO THE RELATED APPLICATIONS

This application is based upon and claims priority to Chinese Patent Application No. 202410796540.9, filed on Jun. 18, 2024, the entire contents of which are incorporated herein by reference.

### TECHNICAL FIELD

The present disclosure relates to the technical field of arch bridges, and more particularly, to a method and a system for setting health monitoring warning thresholds of long-span arch bridges based on reliability criteria.

### BACKGROUND

Long-span arch bridges have become indispensable for mountain and canyon crossings in transport networks due to their exceptional structural stiffness, economic efficiency, and terrain adaptability. However, prolonged service inevitably causes structural degradation from environmental corrosion, heavy traffic loads, and cumulative operational stresses. Establishing scientifically sound warning thresholds is therefore crucial for accurate condition assessment and reliable early-warning capabilities in bridge health monitoring systems.

Current warning threshold methods fall into two categories: monitoring data-based thresholds derived from statistical analysis of short-term measurement variations, and finite element model-based thresholds calculated using design code limits. While data-driven thresholds work for basic alerts, their weak structural state correlation leads to reliability issues and false alarms.

The model-based approach, though theoretically rigorous, inherits design-stage conservatism through worst-case load assumptions and safety factors. This often produces excessively high thresholds that may miss critical structural warnings, creating potential safety risks.

The field therefore requires an innovative solution to establish accurate, reliable warning thresholds for long-span arch bridges, overcoming the limitations of both existing methodologies.

### SUMMARY

Accordingly, the present disclosure provides a method and a system for setting health monitoring warning thresholds of long-span arch bridges based on reliability criteria. The technical solution establishes quantified relationships between structural reliability levels and serviceability states through the bridge's performance function, determines corresponding warning thresholds via inverse reliability analysis targeting predefined reliability indices, and formulates reliability-based criteria for threshold configuration, thereby enabling precise and dependable warning threshold determination for long-span arch bridge monitoring.

To achieve the foregoing objective, the present invention provides the following technical solutions.

A method for setting health monitoring warning thresholds of long-span arch bridges based on reliability criteria includes:
S1: establishing a performance function based on a structural ultimate response and a warning threshold of the long-span arch bridge;
S2: determining a target reliability index, and setting random variables, initial values of the warning thresholds and a convergence tolerance error according to the target reliability index;
S3: calculating a gradient value of the performance function based on the random variables and the initial values of the warning thresholds further calculating a scaling factor based on the gradient value, and obtaining a failure point of the performance function through the scaling factor combined with a conjugate search strategy;
S4: updating the warning threshold at the failure point;
S5: repeating steps S3 and S4 until an iterative error is less than or equal to the convergence tolerance error, and outputting a final warning threshold of the failure point; and
S6: establishing a reliability criterion for warning threshold setting such that a linear relationship is established between the target reliability index and the early-warning threshold, and determining the warning threshold of the target reliability index to be tested according to the reliability criterion.

Preferably, in the step S1, the established performance function includes:

$$G ( u , φ ) = {y}_{R} ( u ) - φ$$

wherein G(u, φ) represents a performance function, u is a multidimensional random variable influencing structural resistance, y_{R}(u) is an ultimate response of the structure; and φ is a warning threshold for structural response;

Preferably, the step S3 specifically includes:
S301: calculating gradient values of the performance function at a point (uₖ,φₖ), where uₖ is an initial value of the random variable and φₖ is an initial value of the warning threshold;
S302: calculating scaling factors based on the gradient values, specifically employing the following formula;

$${θ}_{k} = \frac{{‖ {∇}_{u} {G}_{k} ‖}^{2}}{{‖ {∇}_{u} {G}_{k - 1} ‖}^{2}}$$

S303: calculating a conjugate search direction vector based on the scaling factor;

$${p}_{k} = \{ \begin{matrix}- {∇}_{u} {G}_{k} & k = 0 \\ - {∇}_{u} {G}_{k} + {θ}_{k} {p}_{k - 1} & k \geq 1\end{matrix}$$

S304: calculating iterative checkpoints based on the conjugate search direction vector;

$${u}_{k + 1}^{c} = {u}_{k} + {λ}_{k} {p}_{k}$$

S305: calculating a unit search direction vector based on the iterative checkpoints;

$${α}_{k}^{conjugate} = \frac{{u}_{k + 1}^{c}}{‖ {u}_{k + 1}^{c} ‖}$$

S306: performing inverse reliability analysis to calculate a failure point of the performance function based on the unit search direction vector and the target reliability index β;

$${u}_{k + 1} = {βα}_{k}^{conjugate}$$

wherein, θₖ is a scaling factor, ∇ᵤGₖ is a gradient value of the performance function, Pₖ is a conjugate search direction vector, u^{c}ₖ₊₁ is a recursive check point along the conjugate search direction, λₖ is a finite step length, and uₖ₊₁ is a failure point of the performance function;

Preferably, the step S4 specifically includes:
S401: performing a Taylor series expansion of the performance function at the point (uₖ₊₁,φₖ) with respect to φₖ;

$$G ( {u}_{k + 1} , φ ) = G ( {u}_{k + 1} , {φ}_{k} ) + \frac{\partial G ( {u}_{k + 1} , φ )}{\partial φ} {\vert}_{φ = {φ}_{k}} ( φ - {φ}_{k} ) = 0$$

S402: updating the warning threshold based on the following formula;

$${φ}_{k + 1} = {φ}_{k} - \frac{G ( {u}_{k + 1} , {φ}_{k} )}{\frac{\partial G ( {u}_{k + 1} , φ )}{\partial φ} {\vert}_{φ = {φ}_{k}}}$$

Preferably, the step S6 includes determining whether the iteration satisfies convergence conditions according to the following formula;

$$\frac{\sqrt{{‖ {u}_{k + 1} - {u}_{k} ‖}^{2} + {\vert {φ}_{k + 1} - {φ}_{k} \vert}^{2}}}{\sqrt{{‖ {u}_{k + 1} ‖}^{2} + {\vert {φ}_{k + 1} \vert}^{2}}} \leq ε$$

wherein ε is a convergence tolerance error;

Preferably, the step S6 specifically includes:
S601: establishing a reliability criterion for warning threshold setting such that the target reliability index and the warning threshold satisfy a linear relationship;
S602: calculating any two target reliability indices β₁ and β₂ where β₁<β₂, and the corresponding warning thresholds β₁ and β₂; and
S603: determining a warning threshold under a target reliability index to be tested by interpolation according to the following formula based on the linear relationship.

$$φ = {φ}_{1} + \frac{{φ}_{2} - {φ}_{1}}{{β}_{2} - {β}_{1}} ( β - {β}_{1} )$$

A system for setting health monitoring warning thresholds of long-span arch bridges based on reliability criteria includes:
a performance function establishment module, configured to establish a performance function based on a structural ultimate response of the long-span arch bridge and a warning threshold;
a target index determination module, configured to determine a target reliability index, and set random variables, an initial value of the threshold, and a convergence tolerance error based on the target reliability index; and
a failure point calculation module, configured to calculate a gradient value of the performance function based on the random variables and the initial value of the warning threshold, further calculate a scaling factor based on the gradient value, and obtain a failure point of the performance function through the scaling factor combined with a conjugate search strategy;
a failure point update module, configured to update warning thresholds at the failure points;
an iterative update module, configured to repeat operations of the failure point calculation module and the failure point update module until an iterative error is less than or equal to the convergence tolerance error, and output final warning thresholds of the failure points; and
a warning threshold calculation module, configured to establish reliability criteria for warning threshold configuration such that a linear relationship is satisfied between the target reliability index and the warning thresholds, and derive warning thresholds corresponding to a target reliability index under test according to the reliability criteria.

According to the foregoing technical solutions, compared to the prior art, the present disclosure provides a method and a system for setting health monitoring warning thresholds of long-span arch bridges based on reliability criteria. By establishing a performance function for long-span arch bridges, the innovation links structural reliability levels to service conditions, derives corresponding warning thresholds through inverting target reliability indices, and proposes a reliability-based criterion for warning threshold determination. Leveraging interpolation techniques, the method enables the acquisition of warning thresholds at arbitrary reliability levels, thereby providing an evidence-based and relatively objective approach for threshold configuration. This methodology facilitates refined warning threshold setting and precise structural performance early warning, effectively addressing the inherent subjectivity in conventional threshold determination methods and mitigating missed detections frequently encountered in health monitoring systems.

### BRIEF DESCRIPTION OF THE DRAWINGS

For clearly illustrating the technical solutions in the embodiments of the present disclosure or prior art, the accompanying drawings required for describing the embodiments or prior art will be briefly introduced below. Obviously, the drawings in the following description merely represent embodiments of the present disclosure. Other drawings may be derived by those of ordinary skill in the art from the provided drawings without creative effort.

FIG. 1 is a flowchart illustrating method steps according to the present disclosure;

FIG. 2 is a schematic diagram showing layout of a long-span deck-type reinforced concrete arch bridge for rapid evaluation according to the present disclosure; and

FIG. 3 is a schematic diagram depicting linear relationship between target reliability indices and warning thresholds according to the present disclosure.

### DETAILED DESCRIPTION OF THE EMBODIMENTS

The technical solutions in the embodiments of the present disclosure will be described clearly and completely in conjunction with the accompanying drawings. It is to be understood that the described embodiments represent only a portion of the embodiments of the present disclosure, rather than all possible implementations. All other embodiments obtained by persons of ordinary skill in the art based on the disclosed embodiments without creative effort shall fall within the scope of protection of the present disclosure.

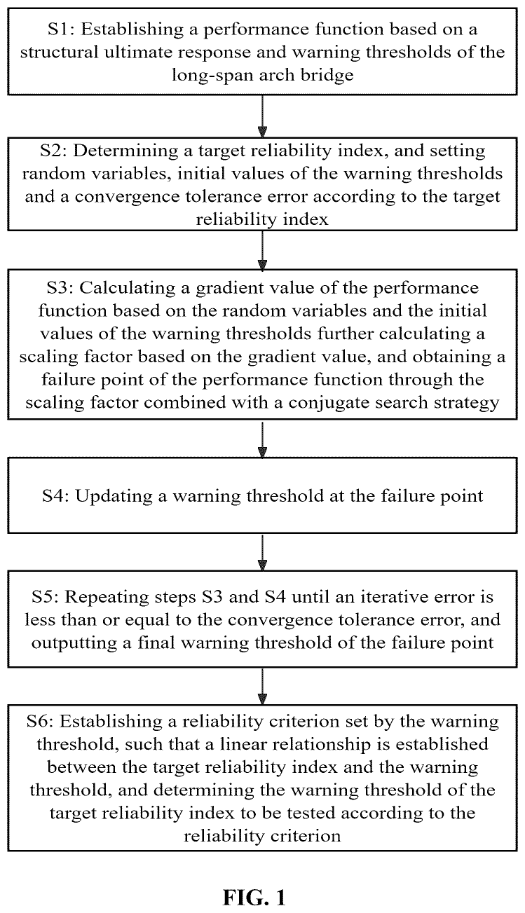

An embodiments of the present disclosure discloses a method for setting health monitoring warning thresholds of long-span arch bridges based on reliability criteria, as illustrated in FIG. 1, including the following steps:
S1: a performance function is established based on the structural limit-state response and warning thresholds of the long-span arch bridge;
S2: a target reliability index is determined, and random variables, initial values of the warning thresholds, and convergence tolerance error are configured based on the target reliability index;
S3: gradient values of the performance function are calculated using the random variables and initial warning thresholds. A scaling factor is derived from the gradient values, and failure points of the performance function are obtained via the scaling factor combined with a conjugate search strategy;
S4: the warning threshold at the failure point is updated;
S5: steps S3 and S4 are repeated until the iteration error is less than or equal to the convergence tolerance error, and the final warning thresholds of the failure points are output; and
S6: a reliability-based criterion for warning threshold setting is formulated to ensure a linear relationship between the target reliability index and the warning thresholds, thereby obtaining the warning thresholds corresponding to the tested target reliability index based on this criterion.

In one specific embodiment, in step S1, the established performance function includes:

G(u,φ)=y_{R}(u)−φ
wherein G(u,φ) is configured to represent a performance function, u is a multidimensional random variable influencing structural resistance, y_{R}(u) is an ultimate response of the structure; and φ is an early-warning threshold for structural response; and
in one specific embodiment, β is configured to represent target reliability index, initial values of random variables uₖ may be configured with their mean values, initial values of predefined warning thresholds φₖ may be configured with zero (0), and convergence tolerance error e may be configured with 10⁻³.

In one specific embodiment, the S3 specifically includes:
S301: the gradient values of the performance function at a point (uₖ,φₖ) are calculated, wherein uₖ is an initial value of the random variable, and φₖ is an initial value of the warning threshold;
S302: the scaling factors are calculated, employing the following formula;

$${θ}_{k} = \frac{{‖ {∇}_{u} {G}_{k} ‖}^{2}}{{‖ {∇}_{u} {G}_{k - 1} ‖}^{2}}$$

S303: a conjugate search direction vector is calculated based on the scaling factor;

$${p}_{k} = \{ \begin{matrix}- {∇}_{u} {G}_{k} & k = 0 \\ - {∇}_{u} {G}_{k} + {θ}_{k} {p}_{k - 1} & k \geq 1\end{matrix}$$

S304: the iterative checkpoints are calculated based on the conjugate search direction vector;

$${u}_{k + 1}^{c} = {u}_{k} + {λ}_{k} {p}_{k}$$

S305: a unit search direction vector is calculated based on the iterative checkpoints;

$${α}_{k}^{conjugate} = \frac{{u}_{k + 1}^{c}}{‖ {u}_{k + 1}^{c} ‖}$$

S306: the inverse reliability analysis is performed to calculate a failure point of the performance function based on the unit search direction vector and the target reliability index β; and

$${u}_{k + 1} = {βα}_{k}^{conjugate}$$

wherein, θₖ is a scaling factor, ∇ᵤGₖ is a gradient value of the performance function, Pₖ is a conjugate search direction vector, u^{c}ₖ₊₁ is a recursive check point along the conjugate search direction, λₖ is a finite step length, and uₖ₊₁ is a failure point of the performance function.

In one specific embodiment, the S4 specifically includes:
S401: a Taylor series expansion of the performance function is performed at the point (uₖ₊₁,φₖ) with respect to φₖ;

$$G ( {u}_{k + 1} , φ ) = G ( {u}_{k + 1} , φ ) + \frac{\partial G ( {u}_{k + 1} , φ )}{\partial φ} {\vert}_{φ = {φ}_{k}} ( φ - {φ}_{k} ) = 0$$

S402: the warning threshold is updated employing the following formula;

$${φ}_{k + 1} = {φ}_{k} - \frac{G ( {u}_{k + 1} , {φ}_{k} )}{\frac{\partial G ( {u}_{k + 1} , φ )}{\partial φ} {\vert}_{φ = {φ}_{k}}}$$

In one specific embodiment, the S5 specifically includes whether the iteration satisfies convergence conditions are determined:

$$\frac{\sqrt{{‖ {u}_{k + 1} - {u}_{k} ‖}^{2} + {\vert {φ}_{k + 1} - {φ}_{k} \vert}^{2}}}{\sqrt{{‖ {u}_{k + 1} ‖}^{2} + {\vert {φ}_{k + 1} \vert}^{2}}} \leq ε$$

wherein ε is a convergence tolerance error.

In one specific embodiment, the S6 specifically includes:
S601: reliability criteria for warning threshold configuration are established, wherein a linear relationship is defined between target reliability indices and corresponding warning thresholds; and
S602: two reference warning thresholds φ₁,φ₂ are calculated for any two target reliability indices β₁ and β₂, (β₁<β₂) respectively;
S603: according to the established linear relationship, the warning threshold corresponding to the target reliability index under test is determined by interpolation according to the following mathematical operation.

$$φ = {φ}_{1} + \frac{{φ}_{2} - {φ}_{1}}{{β}_{2} - {β}_{1}} ( β - {β}_{1} )$$

A system for setting health monitoring warning thresholds of long-span arch bridges based on reliability criteria includes:
a performance function establishment module, configured to establish a performance function based on a structural ultimate response of the long-span arch bridge and a warning threshold;
a target index determination module, configured to determine a target reliability index, and set random variables, an initial value of the warning threshold, and a convergence tolerance error based on the target reliability index; and
a failure point calculation module, configured to calculate a gradient value of the performance function based on the random variables and the initial value of the warning threshold, further calculate a scaling factor based on the gradient value, and obtain a failure point of the performance function through the scaling factor combined with a conjugate search strategy;
a failure point update module, configured to update warning thresholds at the failure points;
an iterative update module, configured to repeat operations of the failure point calculation module and the failure point update module until an iterative error is less than or equal to the convergence tolerance error, and output final warning thresholds of the failure points; and
a warning threshold calculation module, configured to establish reliability criteria for warning threshold configuration such that a linear relationship is satisfied between the target reliability index and the warning thresholds, and derive warning thresholds corresponding to a target reliability index under test according to the reliability criteria.

### Embodiment 1

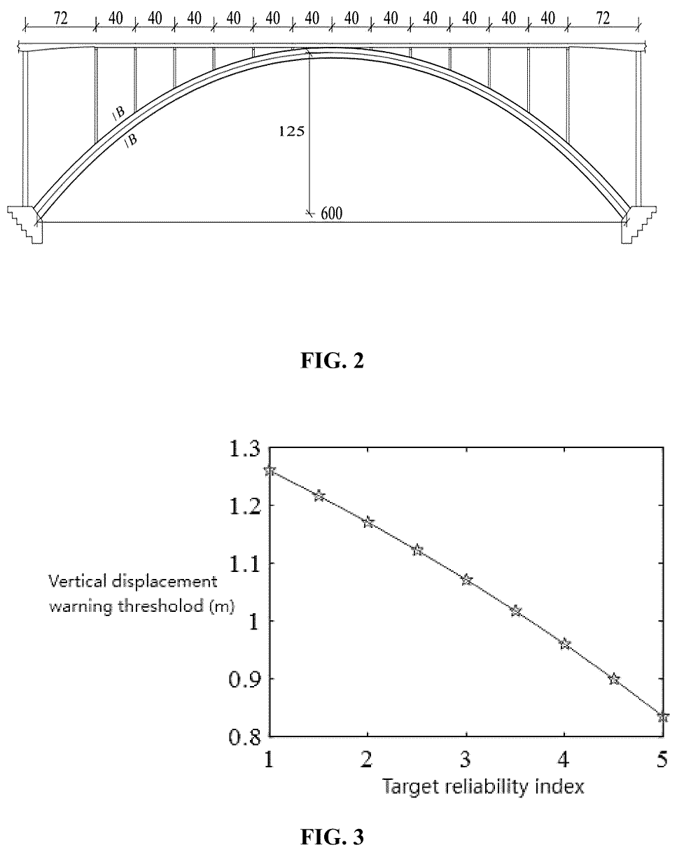

To further describe in detail of the method for setting health monitoring warning thresholds of long-span arch bridges based on reliability criteria in the present disclosure, a long-span deck reinforced concrete arch bridge shown in FIG. 2 was taken as an example for rapid service state assessment and result verification. As illustrated in FIG. 2, the bridge in this embodiment was designed with the following parameters: the main arch axis was constructed with a catenary curve, featuring a calculated span of 600 m and a rise of 125 m; the rise-span ratio (f/l) was set to 1/4.8, with an arch axis coefficient m of 1.9; a single-cell variable-depth box section was adopted for the arch ribs: the arch crown section was designed with a height of 8 m; the arch springing section was configured with a height of 12 m and a width of 6.5 m; the transverse center-to-center distance between arch ribs was maintained at 16.5 m. Two ribs were transversely arranged in a parallel arch configuration. A steel tube concrete truss structure was utilized as the stiff skeleton for the concrete arch ribs: the upper chord tubes were fabricated with an external diameter of 900 mm, where the wall thickness varied gradually from 30 mm at the springing to 35 mm at the crown; the lower chord tubes were manufactured with the external diameter 900 mm, but the wall thickness transitioned inversely from 35 mm at the springing to 30 mm at the crown, Q420qD25Z steel was employed as the material. The external concrete of arch ribs was cast using C60-grade concrete, while C80 self-compacting micro-expansive concrete was poured into the main chord tubes to ensure structural integrity.

The warning threshold setting method for the long-span arch bridge in this embodiment was implemented through the following steps:

### S1: Establishment for Performance Function of Long-Span Arch Bridge

Through ultimate response analysis of the long-span arch bridge, the performance function of the mid-span cross-section was defined as G(u,φ)=y_{R}(u)−φ, where the random variables included: deviation amplitude of the arch axis, uniform temperature variation of the arch ribs, non-uniform temperature variation of the arch ribs, ultimate bending moment of the cross-section, ultimate axial force of the cross-section.

The statistical characteristics of the random variables were summarized in Table 1.

TABLE 1
Random variables and statistical parameters

| | Distribution | Mean | Standard |
|---|---|---|---|
| Random Variable | Type | Value | Deviation |
| deviation amplitude of the | normal | 0 | L/3000 |
| arch axis β(m) | distribution | | |
| uniform temperature | normal | 20 | 4 |
| variation of the arch | distribution | | |
| ribs (t1 + t2) (° C.) | | | |
| non−uniform temperature | normal | 5 | 1 |
| variation of the arch | distribution | | |
| ribs (t1 − t2) (° C.) | | | |
| ultimate bending moment | normal | specified | 0.3 times |
| of the cross-sectionMu | distribution | value | the design |
| (kN · m) | | | value |
| ultimate axial force of | normal | specified | 0.2 times |
| the cross-section Nu (kN) | distribution | value | the design |
| | | | value |

### S2: Determination of Target Reliability Index, and Setting of Random Variables, Initial Values of Warning Thresholds, and Convergence Tolerance Error

For the target reliability index β=5, the following parameters were configured:
the initial failure point was defined as u₀=[0,0,0,0,0]; the initial response limit was set to φ₀=0 m; the step size was fixed at λₖ≡1.2; and the tolerance error was specified as ε=10⁻³.
S3: Obtaining failure point of performance function via conjugate search strategy

The gradient value of the performance function at point (u₀,φ₀) was calculated as

$${∇}_{u} {G}_{0} = [ 0.0326 , - 0.0198 , - 0.0021 , 0.0159 , 0.0493 ] ;$$

the conjugate search direction vector was computed as

$${P}_{0} = - {∇}_{u} {G}_{0} = - [ 0.0326 , - 0.0198 , - 0.0021 , 0.0159 , 0.0493 ] ;$$

the recursive checkpoint was computed as

$${u}_{1}^{c} = {u}_{0} + {λ}_{k} {P}_{0} = - [ 0.0326 , - 0.0198 , - 0.0021 , 0.0159 , 0.0493 ] ;$$

the unit search direction vector was calculated as

$${α}_{k}^{conjugate} = \frac{{u}_{1}^{c}}{▯ {u}_{1}^{c} ▯} = [ - 0.507 , 0.3075 , 0.0328 , - 0.2466 , - 0.7658 ]$$

the failure point of the performance function was calculated;

$${u}_{1} = [ - 2.5352 , 1.5374 , 0.1639 , - 1.2329 , - 3.8291 ] ;$$

### S4: Updating a Warning Threshold at the Failure Point

since the gradient of the performance function with respect to the warning threshold was calculated as −1, and the performance function value at point (u₁,φ₀) was measured as 0.6826 m, the updated threshold was derived as

$${φ}_{1} = {φ}_{0} - 0.6826 / ( - 1 ) = 0.6826 m ;$$

### S5: Repeating Steps S3 and S4 Iteratively Until Satisfying Convergence Criteria, and Outputting Warning Threshold Corresponding to Target Reliability Index

at this stage, the iteration error was 0.9822, which exceeded the tolerance error. Consequently, the iteration process was continued, and steps S3 and S4 were repeated until the warning threshold corresponding to the target reliability index was obtained as 0.835 m.

### S6: Establishment of Reliability Criterion of Warning Threshold Setting, and Achieving Acquisition of Warning Thresholds Under Arbitrary Target Reliability Indices

S601: a reliability criterion for warning threshold setting was established, whereby a linear relationship between the target reliability index and the warning threshold was satisfied;
warning thresholds corresponding to different reliability indices were calculated, as shown in FIG. 3, the method was observed that a linear relationship between the target reliability index and the warning thresholds was essentially satisfied, and a reliability criterion for the warning threshold setting was established;
S602: the warning thresholds φ1 and φ2 corresponding to any two target reliability indices β₁ and β₂ (β₁<β₂) were calculated;

Additionally, the warning threshold corresponding to the target reliability index β=2 was calculated as 1.171 m; and
S603: warning threshold under the specified target reliability index was determined by interpolation using the following formula, through interpolation, warning thresholds corresponding to other target reliability indices could be rapidly calculated. For example, when β=3.5,

$$φ = 0.835 + \frac{1.171 - 0.835}{5 - 2} ( 3.5 - 2 ) = 1.003 m .$$

In summary, a method for setting health monitoring warning thresholds of long-span arch bridges based on reliability criteria is disclosed in the present disclosure. The structural reliability levels are linked to service states based on the performance function of the long-span arch bridge. Corresponding warning thresholds are inversely derived from target reliability indices, and a reliability criterion for threshold setting is proposed. By means of interpolation techniques, warning thresholds under any reliability index are acquired, thereby enabling evidence-based and objective threshold determination. This method achieved refined threshold setting and precise structural performance warning, effectively overcoming the subjectivity inherent in existing threshold determination approaches and avoiding frequent false negatives in health monitoring systems.

In the description of embodiments, each embodiment is described in a progressive manner, with emphasis on differences from other embodiments. Identical or similar parts between embodiments are cross-referenced. For the disclosed device embodiments, descriptions are simplified due to their correspondence with the method embodiments, and relevant details are referenced to the method section.

The descriptions of the disclosed embodiments enabled implementation by professionals skilled in the art. Various modifications to these embodiments would be obvious to skilled practitioners, and the general principles defined herein could be applied to other embodiments without departing from the spirit or scope of the disclosure. Therefore, the present disclosure shall not be limited to the embodiments disclosed herein but shall accord with the broadest scope consistent with the principles and novel features disclosed.

What is claimed is:

1. A method for setting health monitoring warning thresholds of long-span arch bridges based on reliability criteria, comprising:
S1: establishing a performance function based on a structural ultimate response and warning thresholds of the long-span arch bridge;
S2: determining a target reliability index, and setting random variables, initial values of the warning thresholds and a convergence tolerance error according to the target reliability index;
S3: calculating a gradient value of the performance function based on the random variables and the initial values of the warning thresholds further calculating a scaling factor based on the gradient value, and obtaining a failure point of the performance function through the scaling factor combined with a conjugate search strategy;
wherein the S3 comprises:
S301: calculating a gradient value of the performance function at a point (uₖ,φₖ), where uₖ is an initial value of the random variable, and φₖ is an initial value of the warning threshold;
S302: calculating a scaling factor based on the gradient value, employing the following formula;
$${θ}_{k} = \frac{{‖ {∇}_{u} {G}_{k} ‖}^{2}}{{‖ {∇}_{u} {G}_{k - 1} ‖}^{2}}$$
S303: calculating a conjugate search direction vector based on the scaling factor;
$${p}_{k} = \{ \begin{matrix}- {∇}_{u} {G}_{k} & k = 0 \\ - {∇}_{u} {G}_{k} + {θ}_{k} {p}_{k - 1} & k \geq 1\end{matrix}$$
S304: calculating iterative checkpoints based on the conjugate search direction vector;
$${u}_{k + 1}^{c} = {u}_{k} + {λ}_{k} {p}_{k}$$
S305: calculating a unit search direction vector based on the iterative checkpoints;
$${α}_{k}^{conjugate} = \frac{{u}_{k + 1}^{c}}{‖ {u}_{k + 1}^{c} ‖}$$
S306: performing inverse reliability analysis to calculate a failure point of the performance function based on the unit search direction vector and the target reliability index β;
$${u}_{k + 1} = {βα}_{k}^{conjugate}$$
wherein θₖ is a scaling factor, ∇ᵤGₖ is a gradient value of the performance function, Pₖ is a conjugate search direction vector, u^{c}ₖ₊₁ is a recursive check point along the conjugate search direction, λₖ is a finite step length, and uₖ₊₁ is a failure point of the performance function;
S4: updating a warning threshold of the failure point;
S5: repeating steps S3 and S4 until an iterative error is less than or equal to the convergence tolerance error, and outputting a final early-warning threshold of the failure point; and
S6: establishing a reliability criterion for early-warning threshold setting, wherein a linear relationship is established between the target reliability index and the early-warning threshold, and determining the early-warning threshold of the target reliability index to be tested according to the reliability criterion.

2. The method for setting the health monitoring warning thresholds of the long-span arch bridges based on the reliability criteria according to claim 1, wherein in the step S1, the performance function comprises:
$$G ( u , φ ) = {y}_{R} ( u ) - φ$$
wherein G(u, φ) represents a performance function, u is a multidimensional random variable influencing structural resistance, y_{R}(u) is an ultimate response of structure; and φ is an early-warning threshold for structural response.

3. The method for setting the health monitoring warning thresholds of the long-span arch bridges based on the reliability criteria according to claim 1, wherein the step S4 comprises:
S401: performing a Taylor series expansion of the performance function at a point (uₖ₊₁,φₖ) with respect to φₖ;
$$G ( {u}_{k + 1} , φ ) = G ( {u}_{k + 1} , {φ}_{k} ) + \frac{\partial G ( {u}_{k + 1} , φ )}{\partial φ} {\vert}_{φ = {φ}_{k}} ( φ = {φ}_{k} ) = 0$$
S402: updating the warning threshold based on the following formula;
$${φ}_{k + 1} = {φ}_{k} - \frac{G ( {u}_{k + 1} , {φ}_{k} )}{\frac{\partial G ( {u}_{k + 1} , φ )}{\partial φ} {\vert}_{φ = {φ}_{k}}} .$$

4. The method for setting the health monitoring warning thresholds of the long-span arch bridges based on the reliability criteria according to claim 3, wherein the step S5 comprises determining whether iteration satisfies convergence conditions according to the following formula;
$$\frac{\sqrt{{‖ {u}_{k + 1} - {u}_{k} ‖}^{2} + {\vert {φ}_{k + 1} - {φ}_{k} \vert}^{2}}}{\sqrt{{‖ {u}_{k + 1} ‖}^{2} + {\vert {φ}_{k + 1} \vert}^{2}}} \leq ε$$
wherein ε is a convergence tolerance error.

5. The method for setting the health monitoring warning thresholds of the long-span arch bridges based on the reliability criteria according to claim 1, wherein step S6 comprises:
S601: establishing a reliability criterion for warning threshold setting, wherein the target reliability index and the warning threshold satisfy a linear relationship;
S602: calculating any two target reliability indices β₁ and β₂ where β₁<β₂, and corresponding warning thresholds φ₁ and φ₂; and
S603: determining a warning threshold under a target reliability index to be tested by interpolation according to the following formula based on the linear relationship;
$$φ = {φ}_{1} + \frac{{φ}_{2} - {φ}_{1}}{{β}_{2} - {β}_{1}} ( β - {β}_{1} ) .$$

6. (canceled)

7. (canceled)

8. A system for setting health monitoring warning thresholds of long-span arch bridges based on reliability criteria, comprising:
a performance function establishment module, configured to establish a performance function based on a structural ultimate response and a warning threshold of the long-span arch bridge;
a target index determination module, configured to determine a target reliability index, and set random variables, an initial value of the warning threshold, and a convergence tolerance error based on the target reliability index; and
a failure point calculation module, configured to calculate a gradient value of the performance function based on the random variables and the initial value of the warning threshold, further calculate a scaling factor based on the gradient value, and obtain a failure point of the performance function through the scaling factor combined with a conjugate search strategy;
wherein the failure point calculation module comprises:
calculating gradient values of the performance function at a point (uₖ,φₖ), where uₖ is an initial value of the random variable and φₖ is an initial value of the warning threshold;
calculating scaling factors based on the gradient values, employing the following formula;
$${θ}_{k} = \frac{{‖ {∇}_{u} {G}_{k} ‖}^{2}}{{‖ {∇}_{u} {G}_{k - 1} ‖}^{2}}$$
calculating a conjugate search direction vector according to the scaling factor;
$${p}_{k} = \{ \begin{matrix}- {∇}_{u} {G}_{k} & k = 0 \\ - {∇}_{u} {G}_{k} + {θ}_{k} {p}_{k - 1} & k \geq 1\end{matrix}$$
calculating iterative checkpoints based on the conjugate search direction vector;
$${u}_{k + 1}^{c} = {u}_{k} + {λ}_{k} {p}_{k}$$
calculating a unit search direction vector based on the iterative checkpoints;
$${α}_{k}^{conjugate} = \frac{{u}_{k + 1}^{c}}{‖ {u}_{k + 1}^{c} ‖}$$
performing inverse reliability analysis to calculate a failure point of the performance function based on the unit search direction vector and the target reliability index β;
$${u}_{k + 1} = {βα}_{k}^{conjugate}$$
wherein θₖ is a scaling factor, ∇ᵤGₖ is a gradient value of the performance function, Pₖ is a conjugate search direction vector, uₖ₊₁ is a recursive check point along the conjugate search direction, λₖ is a finite step length, and uₖ₊₁ is a failure point of the performance function;
a failure point update module, configured to update warning thresholds at the failure points;
an iterative update module, configured to repeat operations of the failure point calculation module and the failure point update module until an iterative error is less than or equal to the convergence tolerance error, and output final warning thresholds of the failure points; and
a warning threshold calculation module, configured to establish reliability criteria for warning threshold configuration, wherein a linear relationship is satisfied between the target reliability index and the warning thresholds, and derive warning thresholds corresponding to a target reliability index under test according to the reliability criteria.
